(19) United States
(12) Patent Application Publication
(10) Pub. No.: US 2016/0076676 A1
(43) Pub. Date: Mar. 17, 2016

(54) CONNECTOR DEVICE, CONNECTOR HAVING THE SAME AND TANK FOR HEAT EXCHANGER HAVING THE CONNECTOR

(71) Applicants: DENSO International America, Inc., Southfield, MI (US); DENSO CORPORATION, Kariya-city (JP)

(72) Inventors: Rajeev Sharma, Troy, MI (US); Robert Brinker, Ortonville, MI (US)

(21) Appl. No.: 14/485,850

(22) Filed: Sep. 15, 2014

(51) Int. Cl. F16L 13/00; F16L 13/08; F16L 15/08; F16L 13/02

(52) U.S. Cl. CPC F16L 13/00; F16L 13/02; F16L 13/08; F16L 15/08

(57) ABSTRACT

A connector device has an accommodation space, which is configured to accommodate a nut having an inner thread. The nut is configured to be screwed with a coupler and to be connected with an external pipe through the coupler. The connector device is configured to be fixed to the nut by, for example, crimping.

### TECHNICAL FIELD

The present disclosure relates to a connector device. The present disclosure further relates to a connector having the connector device. The present disclosure further relates to a tank for heat exchanger having the connector.

### BACKGROUND

A heat exchanger generally includes a tank to accumulate a thermal medium such as cooling water or refrigerant. The tank is connected with an external pipe via, for example, a connector and a coupler to form a passage for a thermal medium. In general, the coupler has an outer thread, which is screwed into an inner thread of the connector. It is conceivable to form the inner screw of the connector by applying a machining work on a metallic monoblock such as a cast-aluminum alloy block or a forged aluminum alloy block. It may be desirable to reduce a manufacturing cost of the connector.

### SUMMARY

According to one aspect of the present disclosure, a connector device is configured to be fixed with a nut. The nut has an inner thread. The connector device comprises a bottom wall. The connector device further comprises a plurality of sidewalls integrated with the bottom wall into a single piece to form an accommodation space. The accommodation space is configured to accommodate the nut.

According to another aspect of the present disclosure, a connector comprises a nut having an inner thread. The connector further comprises a connector device accommodating the nut. The connector device is crimped to the nut and integrated together.

According to another aspect of the present disclosure, a connector device is configured to be fixed with a nut, which has an inner thread. The connector device comprises a body being a single piece having a claw and defining an accommodation space therein. The accommodation space is configured to accommodate the nut. The craw is configured to be crimped on the nut.

### BRIEF DESCRIPTION OF THE DRAWINGS

The above and other objects, features and advantages of the present invention will become more apparent from the following detailed description made with reference to the accompanying drawings. In the drawings:

FIG. 1 is an exploded view showing a coupler, a connector, and a tank according to the present disclosure;

FIG. 2 is a front view showing a heat exchanger equipped with the tank;

FIG. 3 is an exploded view showing a nut and a nut holder of the connector;

FIG. 4 is a sectional view showing the nut and the nut holder;

FIG. 5 is a sectional view showing the nut fitted in the nut holder;

FIG. 6 is a sectional view showing the nut and the nut holder to be fixed to the tank;

FIG. 7 is a sectional view showing the coupler to be screwed to the nut; and

FIG. 8 is an exploded view showing the coupler, the connector, and the tank connected to each other.

### DETAILED DESCRIPTION

### Embodiment

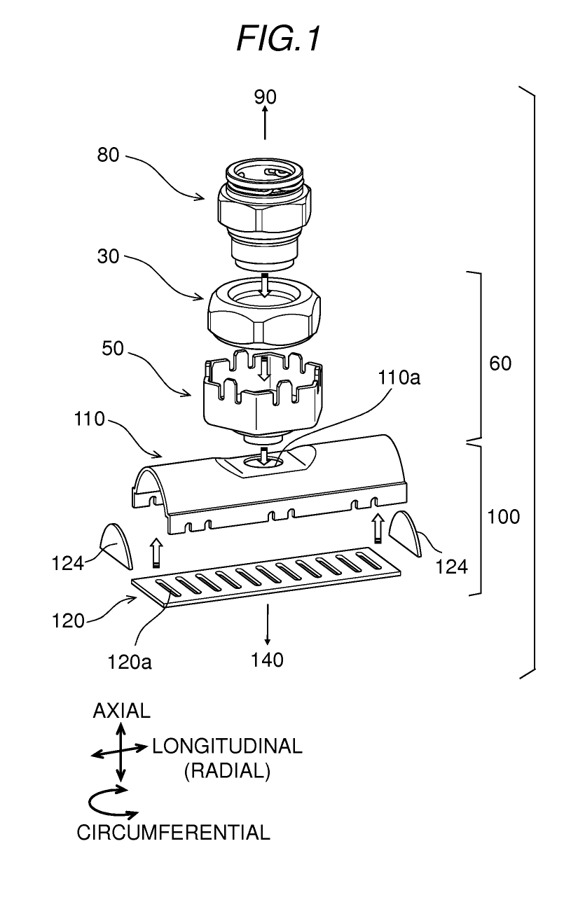

As follows, an embodiment of the present disclosure will be described with reference to FIGS. 1 to 8. In the following description, an axial direction is along an arrow represented by “AXIAL” in drawing(s). A circumferential direction is along an arrow represented by “CIRCUMFERENTIAL” in drawing(s). A longitudinal direction is along an arrow represented by “LONGITUDINAL” in drawing(s). A radial direction is along an arrow represented by “RADIAL” in drawing(s).

As shown in FIG. 1, a connector 60 includes a nut 30 and a nut holder 50. The nut 30 may be a mass-produced component. The nut holder 50 is configured to accommodate the nut 30 therein and to securely hold the nut 30 to be an integrated component.

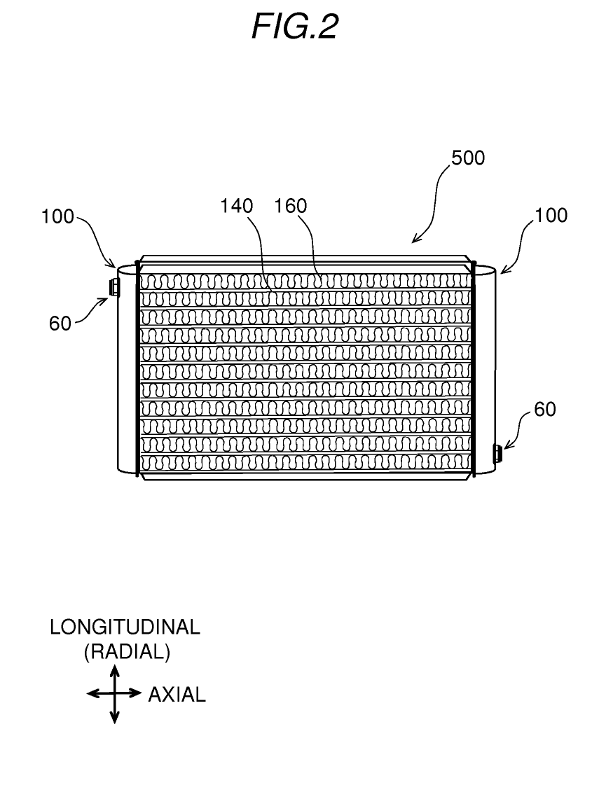

The connector 60 is fixed to a tank 100 of a heat exchanger 500 (FIG. 2). The tank 100 includes a tank member including a tank cover 110, a core plate 120, and end covers 124. The core plate 120 is fixed to the tank cover 110. Ends of the tank 100 are equipped with the end covers 124, respectively, to cover both the ends to define a fluid space therein. An O-ring (not shown) may be provided between the core plate 120 and the tank cover 110 to seal therebetween. The core plate 120 has multiple tube holes 120a, which are connected with one ends of multiple tubes 140, respectively. The tubes 140 are each formed to have an inner passage.

A coupler 80 is screwed into the nut 30 of the connector 60, thereby fixed to the tank 100 via the connector 60. The coupler 80 is coupled with an external pipe 90, which is connected with an external device, such as a pump, a compressor, a valve, and/or another heat exchanger. Thus, the external pipe 90 is communicated with the inner space of the tank 100 through the coupler 80 and the connector 60.

As shown in FIG. 2, the heat exchanger 500 includes two tanks 100 on both lateral sides. The tanks 100 are communicated with each other through the tubes 140. Thus, the connector 60 on the left side in FIG. 2 is in communication with the connector 60 on the right side in FIG. 2 through the inner space of the tank 100 on the left side, the inner passages of the tubes 140, and the inner space of the tank 100 on the right side. Fins 160 are stacked between adjacent two of the tubes 140 to form a fin-and-tube configuration of the heat exchanger 500.

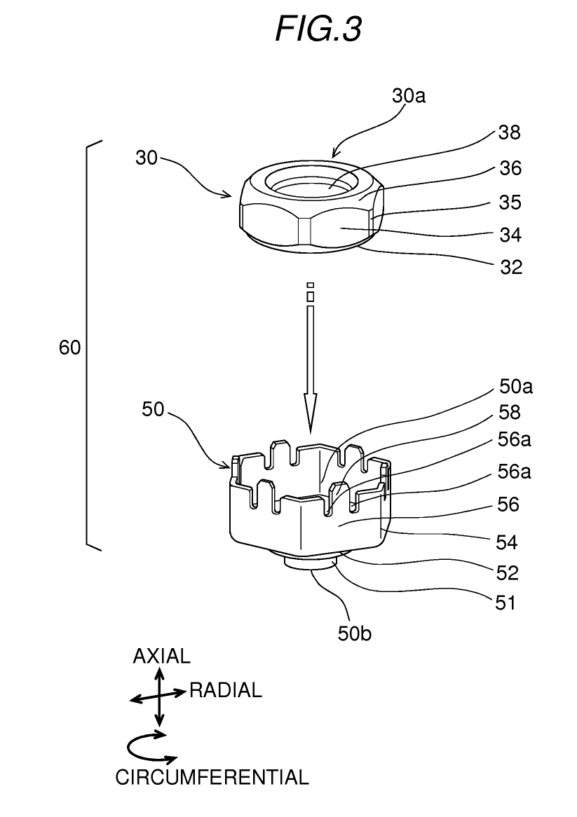

As shown in FIG. 3, the nut 30 may be a generally known hexagonal mechanical component. The nut 30 may be a mass-produced component and may be in compliance with an industrial standard such as ASTEM and/or JIS. The nut 30 may be formed of a metallic material such as aluminum alloy or carbon steel. Alternatively, the nut 30 may be formed of a resin material such as ABS resin. The nut 30 has an inner thread 38, which may be formed by generally known method such as tapping or may be formed when the nut 30 is formed by injection molding or die-casting. The inner thread defines an inner space 30a on the inside in the radial direction. The nut 30 has tapered walls 32, 36 on its lower and upper ends in the axial direction. Each of the tapered walls 32, 36 is formed to extend in the circumferential direction. The nut 30 has six lateral sides 34 and six side edges 35, which are arranged alternately in the circumferential direction.

The nut holder 50 is a hollow component formed of a thin metallic material such as aluminum alloy or carbon steel. The nut holder 50 has six side edges 54 and six sidewalls 56, which are arranged alternately in the circumferential direction. The nut holder 50 further has a bottom wall 52, from which a tubular port 51 is projected. The tubular port 51 defines a passage hole 50b, which forms a fluidic passage. The sidewalls 56 and the bottom wall 52 define an accommodation space 50a for accommodating the nut 30. Each of the sidewalls 56 has a craw 58, which extends in the axial direction. Each of the sidewalls 56 further have two notches 56a interposing the craw 58 in the circumferential direction. The notches 56a are dented into the sidewall 56 in the axial direction. The nut holder 50 has six claws 58 arranged in the circumferential direction at 60-degrees interval.

The nut holder 50 may be formed of a metallic plate by press forming such as punching and/or drawing. For example, the nut holder 50 may be formed by punching a metallic plate into a predetermined shape to have the tubular port 51 and the passage hole 50b and to include the sidewalls 56 and the bottom wall 52. The sidewalls 56 may be bent relative to the bottom wall 52, and adjacent sidewalls 56 may be welded to each other form the accommodation space 50a. Alternatively, the nut holder 50 may be drawn from a metallic plate to have the accommodation space 50a, and thereafter, the claws 58 and notches 56a may be formed by, for example, machining work or laser cutting. The nut holder 50 may function as a connector device (body) 50.

In FIG. 3, the claws 58 are extended substantially straight before the nut 30 is accommodated in the accommodation space 50a of the nut holder 50. As described later, the claws 58 are bent after the nut 30 is accommodated in the accommodation space 50a of the nut holder 50.

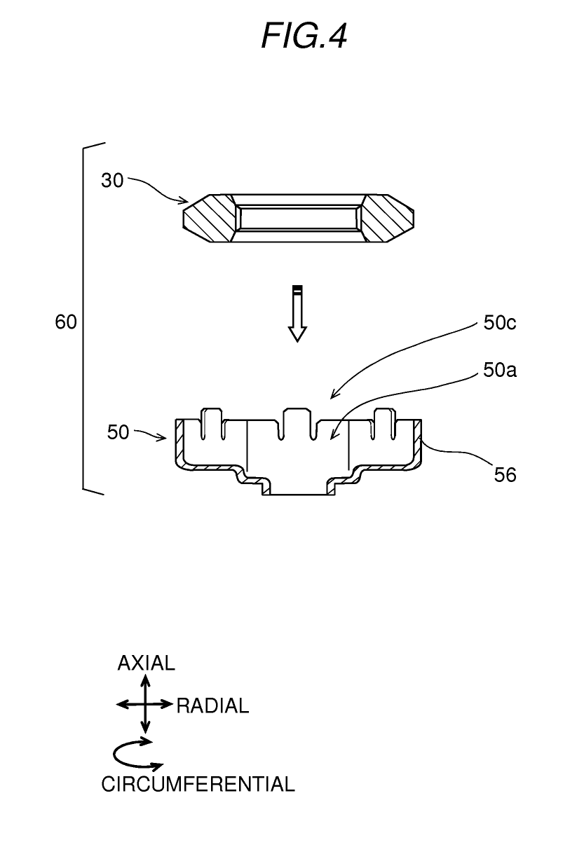

As follows, a manufacturing process of the connector 60 and the tank 100 will be described. As shown in FIG. 4, the nut 30 is mounted into the accommodation space 50a of the nut holder 50 through an opening 50c along the arrow. The nut 30 may be loosely-fitted into the nut holder 50. Alternatively, the nut 30 may be press-fitted into the nut holder 50. The sidewalls 56 may be inclined outward toward the upper side in the drawing to facilitate fitting of the nut 30 into the nut holder 50 and/or to cause the sidewalls 56 to resiliently and frictionally receive the nut 30.

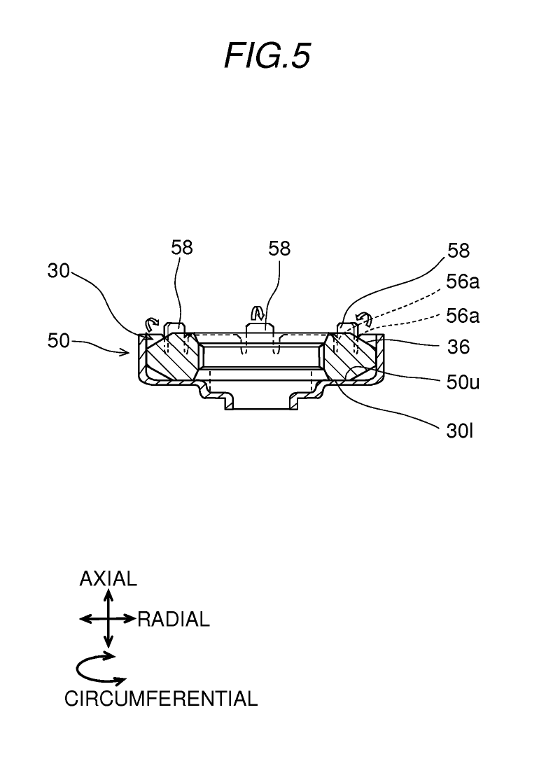

As shown in FIG. 5, the nut 30 is received in the nut holder 50. A lower surface 30l of the nut 30 is in surface contact with an upper surface 50u of the nut holder 50. The claws 58 of the nut holder 50 are bent inward in the radial direction along the arrows. Thus, the claws 58 are crimped onto the tapered wall 36 of the nut 30 to securely hold the nut 30 on the nut holder 50. The notches 56a surround the corresponding claw 58 to facilitate bending of the claw 58 onto the tapered wall 36 of the nut 30 along a bent line.

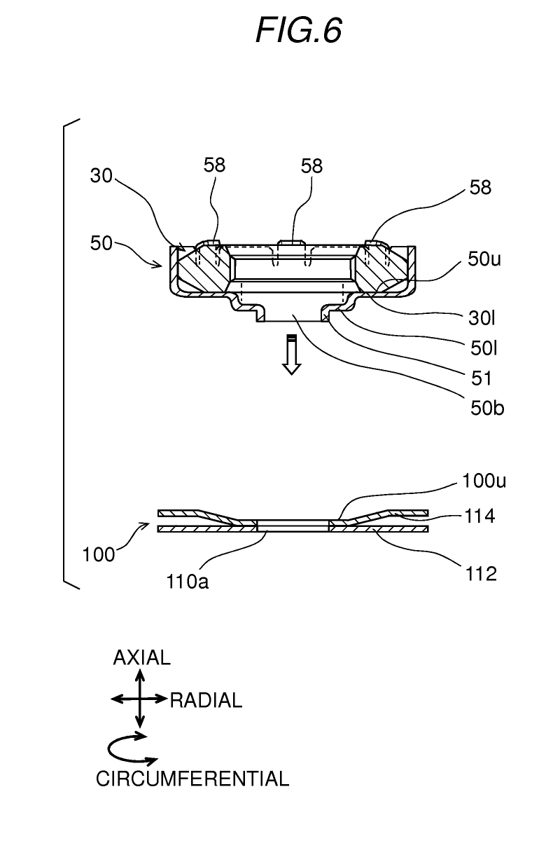

As shown in FIG. 6, the nut 30 and the nut holder 50, which are fixed to each other, are further fixed to the tank 100. Specifically, the tubular port 51 of the nut holder 50 is fitted into a port hole 110a of the tank 100. The tank 100 includes an upper plate 114 and a lower plate 112 stacked together. The upper plate 114 and the lower plate 112 may be formed of a metallic material such as aluminum alloy or carbon steel. Alternatively, the upper plate 114 and the lower plate 112 may be formed of a resin material such as ABS resin. The upper plate 114 and the lower plate 112 may be formed by press-forming or injection molding. The material and the forming process of the upper plate 114 may be different from the material and the forming process of the lower plate 112.

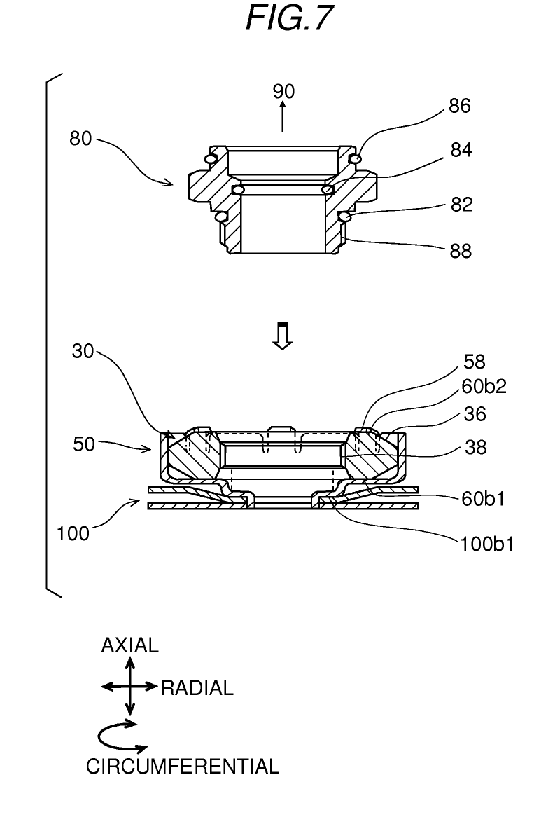

In FIG. 7, the nut 30, the nut holder 50, and the tank 100, which are fixed together, are brazed together. By the brazing, the upper surface 50u (FIG. 6) of the nut holder 50 and the lower surface 30l (FIG. 6) of the nut 30 form a brazed surface 60b1 at which the nut 30 and the nut holder 50 are secured and sealed to each other. In addition, the crimped claws 58 of the nut holder 50 and the tapered wall 36 of the nut 30 form a brazed surface 60b2 at which the nut 30 and the nut holder 50 are secured to each other. In addition, a lower surface 50l (FIG. 6) of the nut holder 50 and an upper surface 100u (FIG. 6) of the tank 100 are in surface contact with each other and are brazed to each other to form a brazed surface 100b1. Thus, the nut holder 50 and the tank 100 are secured and sealed to each other at the brazed surface 100b1.

The coupler 80 is screwed into the nut 30 along the axial direction by using, for example, a wrench. Thus, an outer thread 88 of the coupler 80 is meshed with the inner thread of the nut 30. The coupler 80 is equipped with O-rings 82, 84 on its outer periphery. When the coupler 80 is screwed to the nut 30, the O-ring 82 is elastically interposed between the coupler 80 and the nut 30 to seal therebetween. The coupler 80 is further equipped with a spring 86 to enable connection with the external pipe 90. The coupler 80 may function as a quick connector (one-touch connector) configured to be coupled with the external pipe 90 by an operators hands without using a tool. In this case, the external pipe 90 can be resiliently detachable to the coupler 80 via the spring 86. When the external pipe 90 is coupled with the coupler 80, the O-ring 84 seals between the external pipe 90 and the coupler 80.

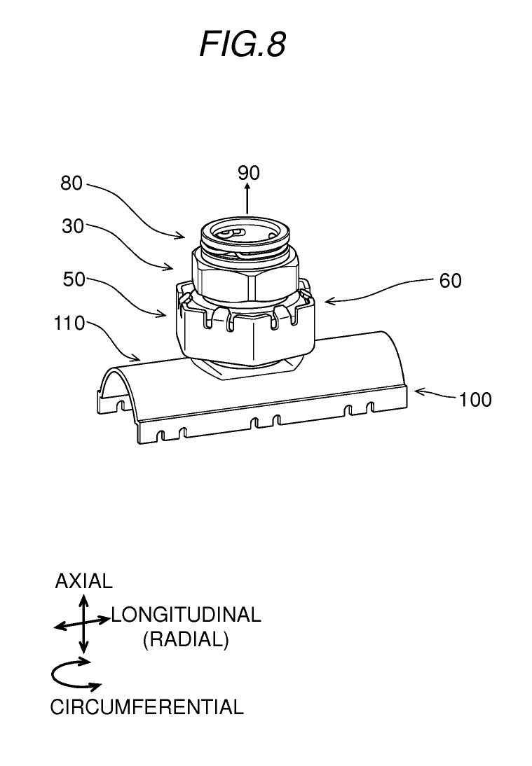

As shown in FIG. 8, the coupler 80, the nut 30, the nut holder 50, and the tank 100 are connected to each other in this order downward in the drawing. The nut 30, the nut holder 50, and the coupler 80 are substantially coaxial with each other along the common axis in the axial direction.

### Effect

The configuration enables a manufacturer to reduce a machining work when forming the connector 60 having the inner thread 38. Specifically, a manufacturer may purchase a low-cost standard nut 30 to obtain a core component of the connector 60. Thus, a manufacturer may have various options of the nut 30 and may select the nut 30 in consideration of its specification such as its quality, its material, its size, its price and/or the like. The nut holder 50 may be formed in a low-cost manufacturing process such as press forming, drawing, welding, and/or the like. Thus, the connector 60 can be manufactured at low cost compared with a configuration such as machined monoblock material.

The nut holder 50 is crimped on the nut 30. In addition, the nut 30, the nut holder 50, and the tank 100 are brazed together into a single component. Therefore, seams (interfaces) formed among the nut 30, the nut holder 50, and the tank 100 are fixed and sealed together at the brazed surfaces. Thus, without using a monoblock structure, the integrated components may form the fluid passage and the inner space, which are sealed from the outside.

The present configuration enables to employ different materials for the nut 30, the nut holder 50, and the tank 100 in consideration of those purposes.

### Other Embodiment

The nut 30 is not limited to the hexagonal member and may be have various shapes. The nut holder 50 may have various shapes in accordance with the shape of the nut 30.

The manufacturing method for the nut 30 does not exclude a machining work. The nut 30 may be formed by, for example, a machining work, as a one-made product. The nut holder 50 may be formed by machining.

The notches 56a may be omitted from the sidewalls 56 of the nut holder 50.

The nut holder 50 may be fixed to the tank 100, and thereafter, the nut 30 may be fitted in and crimped to the nut holder 50.

The tubular port 51 of the nut holder 50 may be elongated in the radial direction after being fixed to the port hole 110a of the tank 100 to further secure the nut holder 50 to the tank 100.

Instead of or in addition to the crimping, the nut holder 50 may be fixed to the nut 30 by another method. For example, the nut holder 50 may be welded with the nut 30. For example, solder may be charged into a gap between the nut holder 50 and the nut 30, when the nut 30 is accommodated in the accommodation space 50a, to integrate the nut 30 and the nut holder 50 into a single piece.

An O-ring may be interposed between the nut holder 50 and the nut 30. The O-ring may be located in a place formed among the bottom wall 52 of the nut holder 50, the sidewalls 56 of the nut holder 50, and the tapered wall 32 of the nut 30.

The number of the craws 58 may be arbitrarily determined. The craws 58 may be arranged to be point-symmetric to each other along the circumferential direction. The craws may be provided point-symmetrically at, for example, two positions, three positions, or six positions. Two claws 58 may be provided in the circumferential direction at 180-degrees interval. Three claws 58 may be provided in the circumferential direction at 120-degrees interval.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A connector device configured to be fixed with a nut, the nut having an inner thread, the connector device comprising;
a bottom wall; and
a plurality of sidewalls integrated with the bottom wall into a single piece to form an accommodation space, wherein
the accommodation space is configured to accommodate the nut.

2. The connector device according to claim 1, wherein
at least one of the sidewalls has a craw, and
the craw is configured to be crimped onto the nut.

3. The connector device according to claim 2, wherein the craw is projected from the sidewall and configured to be bent toward the nut.

4. The connector device according to claim 3, wherein the craw is interposed between notches each being recessed into the at least one of the sidewalls.

5. The connector device according to claim 4, wherein the craw is configured to be bent onto a tapered wall of the nut and to be crimped onto the tapered wall.

6. The connector device according to claim 1, wherein the bottom wall has a surface configured to be in surface contact with a surface of the nut.

7. The connector device according to claim 1, wherein the sidewalls are configured to be press-fitted with the nut.

8. The connector device according to claim 1, further comprising:
a port projected from the bottom wall and located on an opposite side of the bottom wall from the sidewalls, wherein
the port defines a passage hole communicated with the accommodation space.

9. The connector device according to claim 1, wherein the sidewalls are configured to be brazed with the nut, soldered with the nut, or welded with the nut.

10. The connector device according to claim 1, wherein the sidewalls include six sidewalls.

11. A connector comprising;
a nut having an inner thread; and
a connector device accommodating the nut, wherein
the connector device is crimped to the nut and integrated together.

12. The connector according to claim 11, wherein the connector device has at least one craw bent toward the nut and crimped onto the nut.

13. The connector according to claim 11, wherein
the connector device and the nut are brazed and integrated into one component, and
the connector device is in surface contact with the nut via a brazed surface at which the connector device is fixed to and sealed with the nut.

14. The connector according to claim 11, wherein
the connector device includes a bottom wall and a port integrated with each other,
the bottom wall is in contact with the nut,
the port is projected from the bottom wall and located on an opposite side of the bottom wall from the nut, and
the port defines a passage hole communicated with an inner space of the nut.

15. The connector according to claim 11, wherein the connector device is fixed to the nut by brazing, soldering, or welding.

16. The connector according to claim 12, wherein the at least one craw includes six craws.

17. A tank for a heat exchanger, the tank comprising:
a tank member defining a fluid space therein; and
the connector according to claim 11, wherein
the tank member, the nut, and the connector device are brazed and integrated into one component.

18. The tank according to claim 17, wherein
the connector device has a craw projected from the connector device, and
the craw is bent toward the nut and crimped onto the nut.

19. The tank according to claim 18, wherein
the connector device includes a bottom wall and a port integrated with each other,
the bottom wall is in contact with the nut,
the port is projected from the bottom wall and located on an opposite side of the bottom wall from the nut,
the port is inserted in a port hole of the tank member, and
the port defines a passage hole communicated with an inner space of the nut and the fluid space in the tank member.

20. A connector device configured to be fixed with a nut, which has an inner thread, the connector device comprising;
a body being a single piece having a claw and defining an accommodation space therein, wherein
the accommodation space is configured to accommodate the nut, and
the craw is configured to be crimped on the nut.
